(19) United States
(12) Patent Application Publication
(10) Pub. No.: US 2015/0202920 A1
(43) Pub. Date: Jul. 23, 2015

(54) APPARATUS FOR HANDLING A VEHICLE WHEEL

(71) Applicants: Woon Tiong Ang, Edmonton (CA); Alan Mui Thiam Lim, Edmonton (CA)

(72) Inventors: Woon Tiong Ang, Edmonton (CA); Alan Mui Thiam Lim, Edmonton (CA)

(21) Appl. No.: 14/160,226

(22) Filed: Jan. 21, 2014

(51) Int. Cl. B60B 29/00; B60B 30/10; B60B 30/02

(52) U.S. Cl. CPC B60B 29/001; B60B 30/02; B60B 30/10; B60B 29/002

(57) ABSTRACT

A vehicle wheel handler comprises a base frame comprising base arms and an end base member forming a generally U-shape. A mobile frame comprises supporting arms and an end member forming a generally U-shape. An elevation guide system is joined to the base aims and disposed proximate a distal end of the base arm. The elevation guide system is configured for slidable engagement with a one of the supporting aims to enable vertical movement of the mobile frame. A roller support system is joined to the supporting arms to enable a rotational positioning of a supported vehicle wheel. A lifting member is joined to the supporting aims. A lever frame comprises a handle and lever arms. The lever arms are in pivotal engagement with the base arms and in engagement with the lifting member for enabling a vertical positioning of the supported vehicle wheel.

### CROSS-REFERENCE TO RELATED APPLICATIONS

The present Utility patent application claims priority benefit of the U.S. provisional application for patent Ser. No. 61,755,458 entitled “Apparatus for Handling a Vehicle Wheel”, filed on Jan. 22, 2013, under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to automotive equipment. More particularly, the invention relates to an apparatus for handling a vehicle wheel.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Vehicle wheels are often heavy and cumbersome, which may make the handling of wheels, especially when mounting wheels on wheel hubs, a difficult task for one person to accomplish. Vehicle wheels may be removed and replaced for a variety of reasons such as, but not limited to, maintenance, repair, customization, etc. Even though an average person is typically capable of lifting a tire-mounted wheel of a passenger car off of the ground, one can expect that this may be a physically-demanding endeavor for some individuals when attempting to align the lug nut holes of the rim with the wheel studs on the wheel hub while lifting the wheel.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, an aspect of the prior art generally useful to be aware of is that a variety of devices are currently available for aiding in the task of removing and/or mounting vehicle wheels. For example, without limitation, some hydraulic car jacks and dollies may be used for handling wheels. These devices are generally designed for jacking up cars, not for mounting wheels and may not be easily adapted for use with wheels. Moreover, it is believed that hydraulic jacks typically provide a choppy or step-like movement which may make precise height adjustment difficult, and hydraulic jacks are typically heavy. Some current wheel handling devices may be useful for removing wheels yet not suitable for wheel-mounting. For example, without limitation, some devices may not comprise means for lug nut hole alignment or may have no elevating mechanism. Some existing wheel handling and lifting mechanisms may use a toe-lift mechanism. It is believed that toe lift mechanisms typically require the use of strong, thick materials and joints or plenty of bracing for structural rigidity due to the potential of several high stress points within the toe lift structure. The need for strong, thick materials typically rules out the use of lightweight material, which may result in making the overall structures of these mechanisms heavy and cumbersome to use. This may also increase material and manufacturing costs. One may expect that the use of braces may lead to ergonomic issues. For instance, without limitation, the braces may get in the way of the wheel movement trajectory. Some current devices for handling a vehicle wheel may not work on all wheels. For example, without limitation, some devices may only be used on rims with a specific groove. In addition, some existing devices may be cumbersome, heavy, unwieldy, or simply difficult or inconvenient to use. For example, without limitation, one such device has several moving parts and may be inconvenient to operate. Other such devices may require a great deal of space to operate. In other such devices height adjustment may be achieved by turning a stub or nut on the apparatus, which may be inconvenient as this may require an additional socket driver. Furthermore, this type of turning mechanism may not feel responsive to the user as translating rotational motion into linear motion by hand is typically a slow process.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, 1C, 1D, and 1E illustrate an exemplary wheel handling apparatus, in accordance with an embodiment of the present invention. FIG. 1A is a side perspective view. FIG. 1B is a top perspective view. FIG. 1C is a front perspective view. FIG. 1D is a rear perspective view, and FIG. 1E is an additional side perspective view;

FIG. 2 is a front perspective view of an exemplary roller support system for a wheel handling apparatus, in accordance with an embodiment of the present invention;

FIGS. 3A and 3B illustrate a wheel on an exemplary wheel handling apparatus, in accordance with an embodiment of the present invention. FIG. 3A is a front perspective view of the wheel resting, with stability, on the apparatus, and FIG. 3B is a front perspective view of the wheel being lifted by the apparatus;

FIGS. 4A, 4B, and 4C illustrate an exemplary braking system for a wheel handling apparatus, in accordance with an embodiment of the present invention. FIG. 4A is a top perspective view of the braking system in a locked position. FIG. 4B is a top perspective view of the braking system in a released position, and FIG. 4C is a front perspective view of a brake linkage in use;

FIGS. 5A, 5B, 5C and 5D illustrate exemplary elevation guidance systems for a mobile frame of a wheel handling apparatus, in accordance with embodiments of the present invention. FIG. 5A is a front perspective view of an exemplary interdigitated slider. FIG. 5B is a front perspective view of an exemplary ring-on-post slider. FIG. 5C is a front perspective view of an exemplary linkage system, and FIG. 5D is a partial front perspective view of an exemplary rolling system;

FIGS. 6A and 6B illustrate an exemplary braking system for a wheel handling apparatus comprising a central brake, in accordance with an embodiment of the present invention. FIG. 6A is a side perspective view of the apparatus, and FIG. 6B is a top view of the central brake;

FIG. 7 is a diagrammatic side view of an exemplary wheel handling apparatus, in accordance with an embodiment of the present invention, and

FIG. 8 is a diagrammatic side view of an exemplary wheel handling apparatus, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide an apparatus for handling a vehicle wheel. This embodiment may be used mainly for mounting wheels yet may also be used for removing wheels and may act as a counter weight. Some embodiments provide an efficient mechanism for a user to mount a wheel on a vehicle's wheel hub comprising means of adjusting the position and orientation of the wheels such that the wheel can be smoothly slid onto the wheel hub of a vehicle. In some embodiments this mechanism may allow multiple degrees of freedom in the motion of the wheel including, without limitation, vertical height, arbitrary motion along the plane of the ground, and clockwise or counterclockwise rotation along the axis of the wheel. In this manner, a wheel can be adjusted to the proper position and its lug nut holes aligned with the studs on the wheel hub such that the wheel can be easily slid into position on the wheel hub.

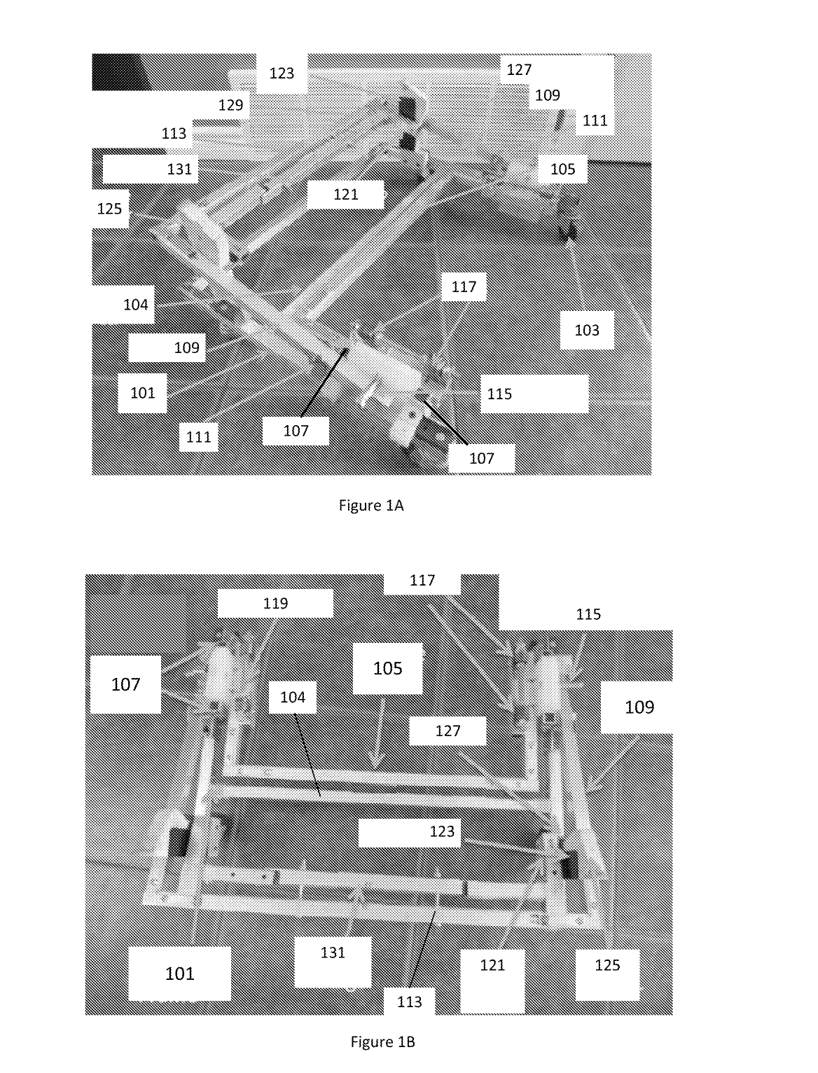

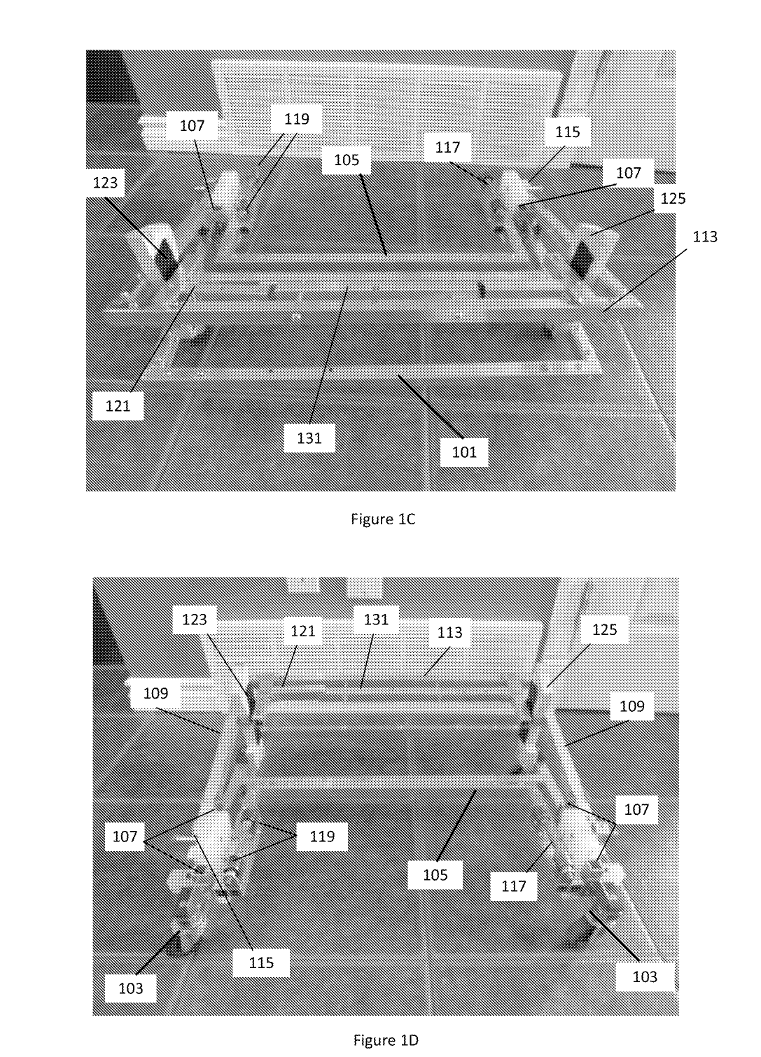

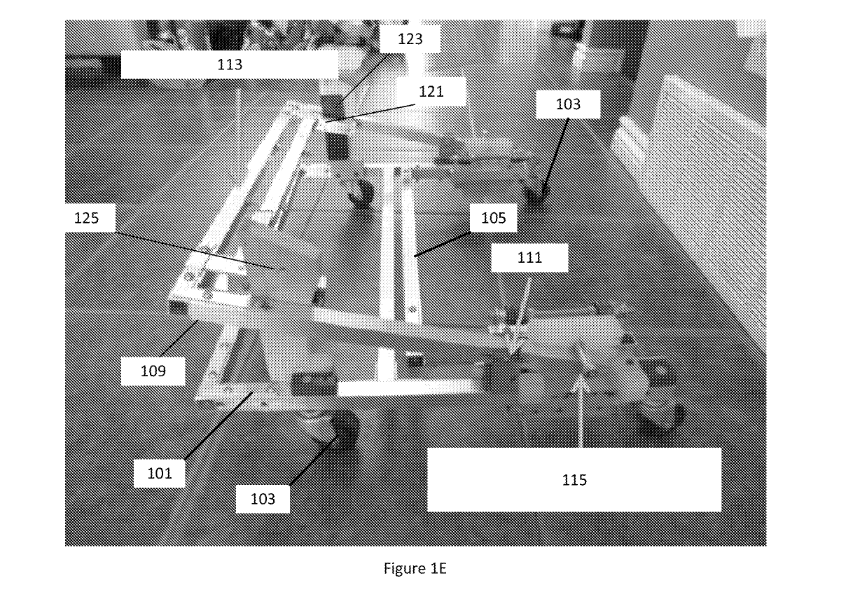

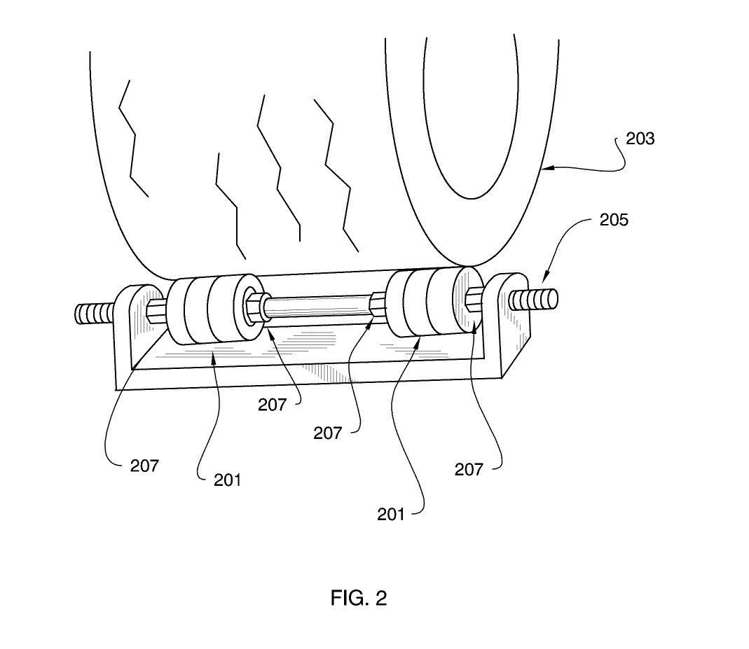

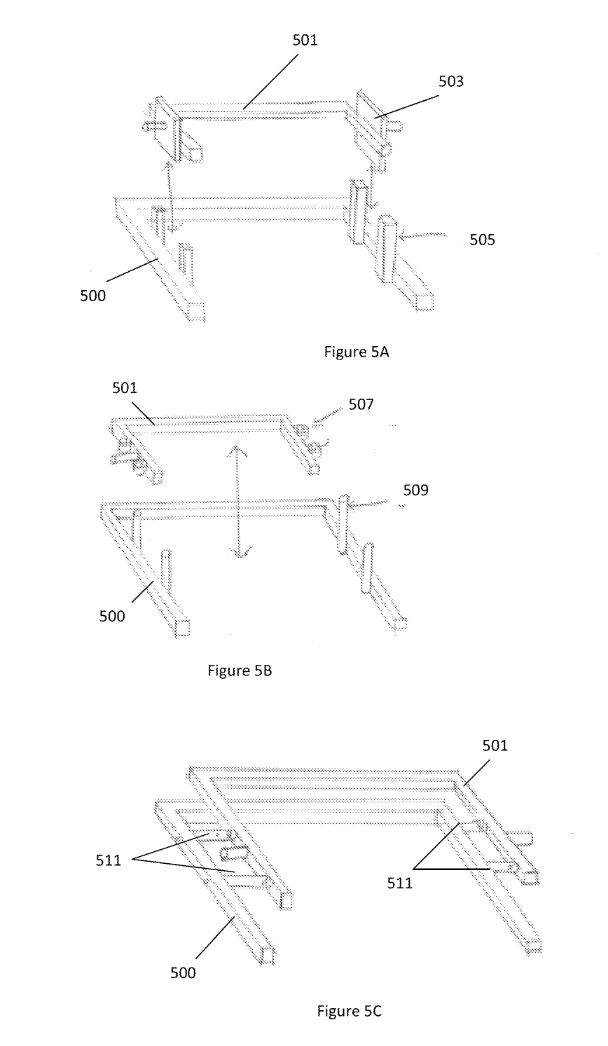

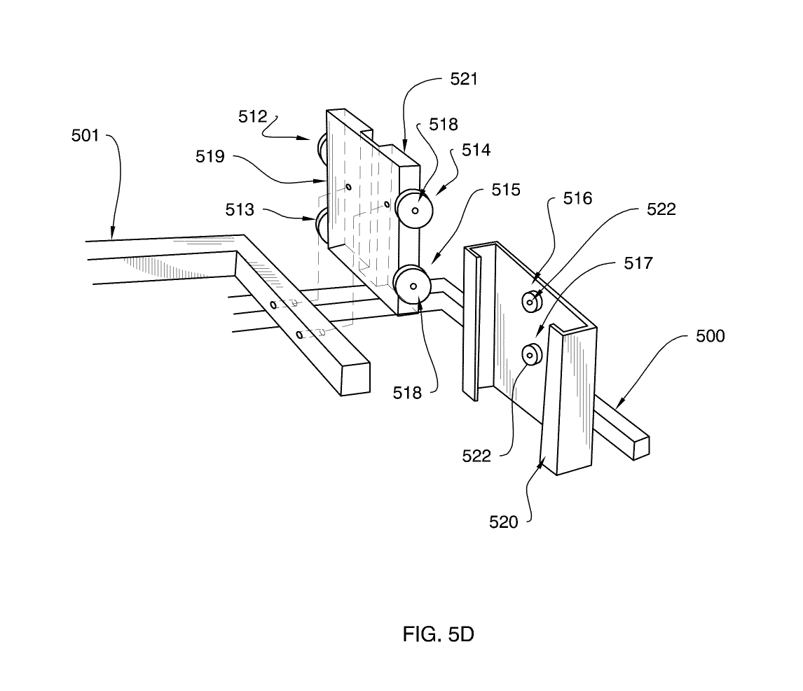

FIGS. 1A, 1B, 1C, 1D, and 1E illustrate an exemplary wheel handling apparatus, in accordance with an embodiment of the present invention. FIG. 1A is a side perspective view. FIG. 1B is a top perspective view. FIG. 1C is a front perspective view. FIG. 1D is a rear perspective view, and FIG. 1E is an additional side perspective view. In the present embodiment, the apparatus comprises a base frame 101 supported by four castor wheels 103, one at each corner. A stabilizer bar 104 may provide support and strength to base fame 101. A U-shaped mobile frame 105 that can be elevated sits inside base frame 101. In some embodiments, the mobile frame may sit on top of the base frame. In the present embodiment, mobile frame 105 slides vertically along an elevation guide 107 secured to each side of base frame 101. It is contemplated that a multiplicity of suitable means may be implemented as the elevation guide such as, but not limited to, an interdigitated slider, a ring-on-post slider, a linkage system, a rolling system etc. FIGS. 5A, 5B, 5C and 5D illustrate some of these elevation guidance systems by way of example. Furthermore, those skilled in the art will readily recognize, in light of and in accordance with the teachings of the present invention, that the frames in some alternate embodiments may be implemented in various different shapes and sizes. For example, without limitation, in some embodiments the base frame, mobile frame and the lever aims may be bent or curved rather than straight or angled throughout. In the present embodiment, many of the components including, without limitation, base frame 101 and mobile frame 105 are made of aluminum. However, it is contemplated that a multiplicity of alternate materials may be suitable such as, but not limited to, various different metals or plastics, fiberglass, composite materials, etc. Furthermore, different construction means may be used assemble the apparatus including, without limitation, welding, bolt and nut, screws, etc. In addition, some embodiments may comprise various different types of means for repositioning other than castor wheels such as, but not limited to, ball transfer units or furniture sliders, and other embodiments may comprise no means for repositioning. In some embodiments, the means for repositioning may comprise a brake or brakes to hold the apparatus stationary.

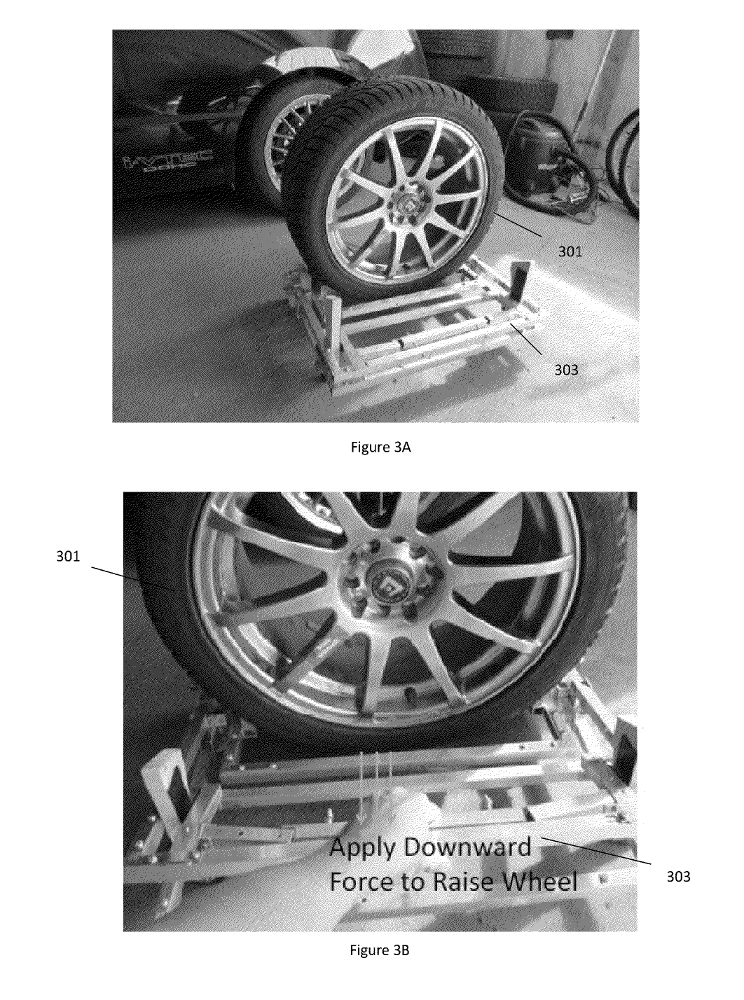

In the present embodiment, a lever mechanism comprising lever arms 109 on pivots 111 may be used to elevate mobile frame 105. Lever aims 109 are connected at one end by a handle bar 113, and the other ends of each lever arm 109 are positioned under elevating rods 115, which are connected to mobile frame 105 near elevation guides 107. To raise mobile frame 105, a user may push handle bar 113 downward, which typically causes the opposite ends of lever arms 109 to raise, thus lifting elevating rods 115 and mobile frame 105. Conversely, to lower mobile frame 105, the user may allow handle bar 113 to move up to a higher position while controlling the speed of the movement with resistance. The position of pivots 111 along the length of lever arms 109 typically affects the amount of leverage provided by lever arms 109. In the present embodiment, pivots 111 are positioned ¾ of the length of lever aims 109 away from handle bar 113, thus generally providing a force of leverage of 1:4 meaning the user typically needs to exert only 1 lb. of force for every 4 lbs. of weight exerted by the load. The placement of the pivot in some embodiments may vary depending on a multiplicity of factors such as, but not limited to, the size of the apparatus, the size of the wheel being lifted, user preference, etc. For example, without limitation, a user may wish to increase the leverage ratio so as to lighten the effort required while performing height adjustment. The use of a lever mechanism to lift a wheel is illustrated by way of example in FIG. 3B. In the present embodiment, on mobile frame 105 are rollers 117 that may facilitate wheel rotation for lug nut alignment. Rollers 117 can, yet are not required, to extend the full length of roller axles 119 on which rollers 117 are installed. A roller support system is shown by way of example in FIG. 2.

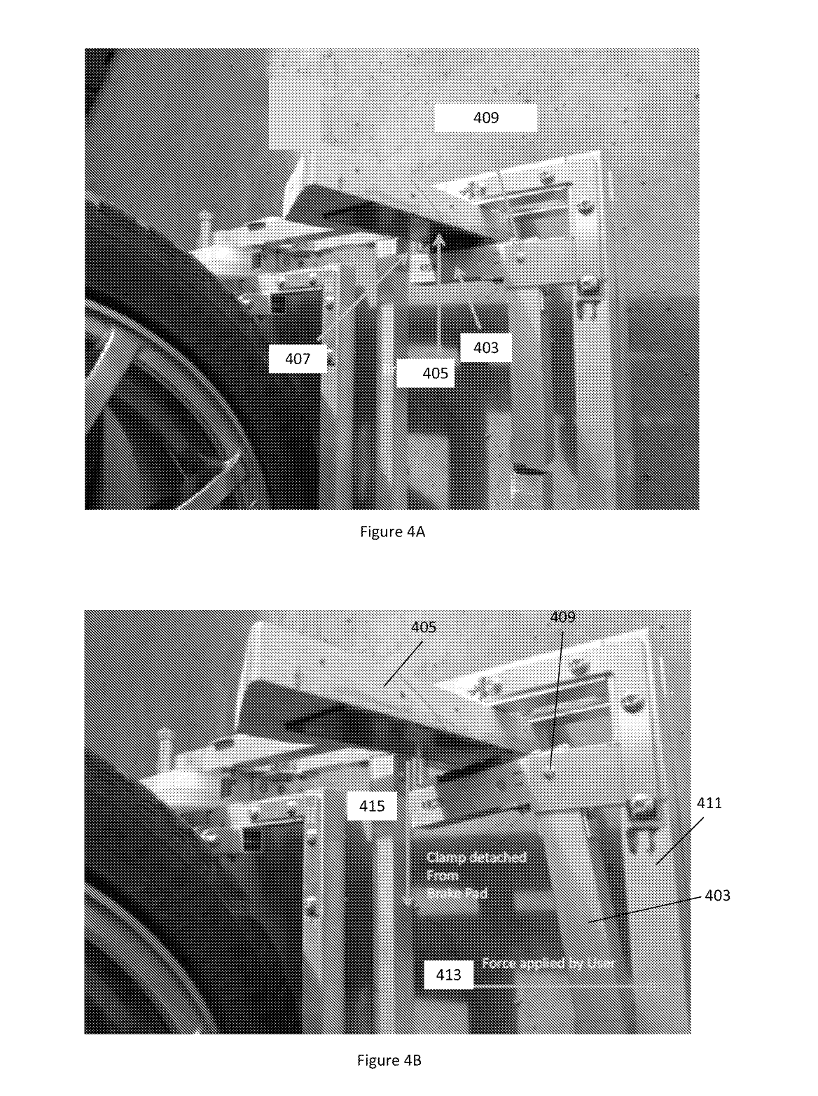

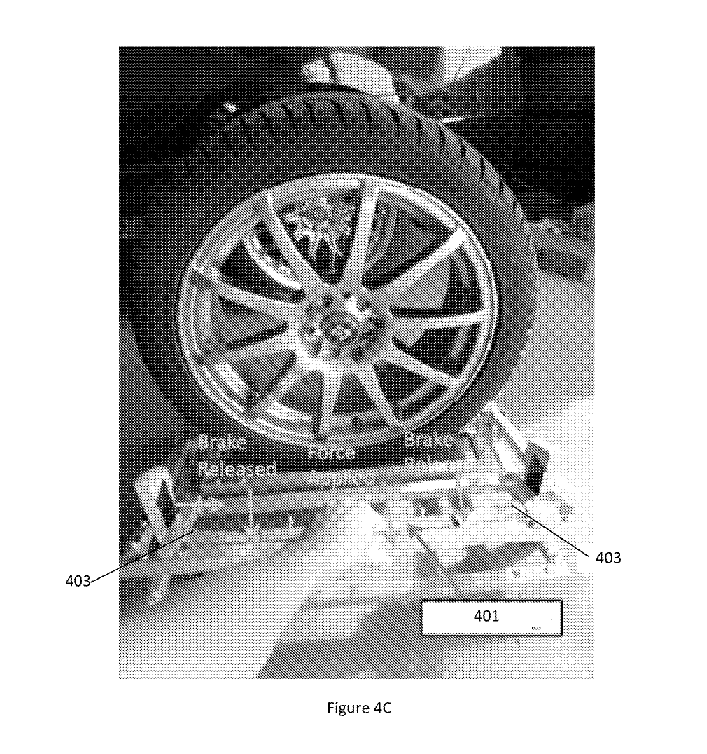

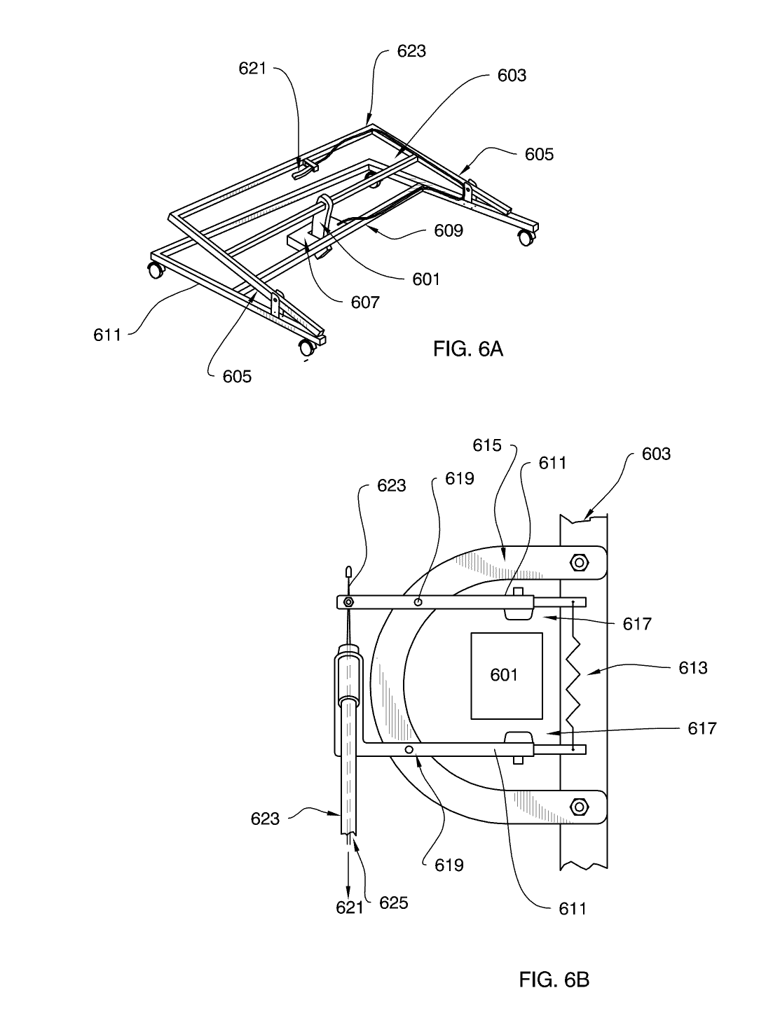

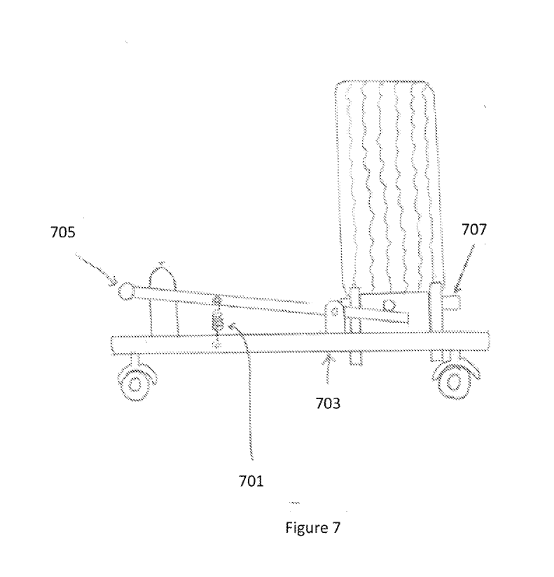

Attempting to hold the wheel at a certain elevated height may be challenging, especially while the user is trying to rotate the wheel or maneuver the apparatus horizontally to align the wheel with the lug nuts. Therefore, in the present embodiment, the apparatus comprises a braking system. A close-up view of a braking system for a wheel handling apparatus is illustrated by way of example in FIG. 4A and FIG. 4B. The brake system comprises a brake mechanism on each side of the apparatus comprising an L-shaped clamp 121 that is normally pressed against a brake pad 123 on a brake tower 125 due to tension from a spring 127. This means that the lever mechanism in typically locked in place when the brake mechanism not being engaged by the user. When the user engages the brake mechanism by applying a force on clamp 121 towards handle bar 113, clamp 121 is typically released from brake pad 123 about a pivot 129 so that the lever mechanism is free to move. Since there are two identical braking mechanisms, one on each side of the apparatus, both brake mechanisms typically need to be released to allow the lever mechanism to move. This maneuver may require the use of both the left and right hand of the user, thus generally preventing the user from doing another task while engaging the brake mechanism such as, but not limited to, tire rotation or lug nut alignment. A brake linkage 131 is therefore included, without limitation, on the apparatus to typically allow the user to release both brake mechanisms with one hand. A brake linkage mechanism is illustrated by way of example in FIG. 4C. Those skilled in the art will readily recognize, in light of and in accordance with the teachings of the present invention, that a multiplicity of suitable braking systems may be implemented in some alternate embodiments. For example, without limitation, some embodiments may not comprise a brake linkage, and some embodiments may comprise only one brake. Other embodiments may use means other than friction brakes to hold the lever mechanism in place such as, but not limited to, locking pins, spring loaded latches, ratcheting mechanisms, clamps, etc. FIGS. 6A and 6B illustrate by way of example alternate braking mechanisms for wheel handling apparatuses.

FIG. 2 is a front perspective view of an exemplary roller support system for a wheel handling apparatus, in accordance with an embodiment of the present invention. In the present embodiment, rollers 201 may facilitate the rotation of a wheel 203 for lug nut alignment. Rollers 201 are positioned on opposite ends of an axle 205, which may be threaded in some areas. In some embodiments, rollers may extend the full length of the roller axle. In some applications there may be an advantage to positioning the rollers only at the ends of the axle as this may help with stability of the wheel and may generally prevent the wheel from toppling over as easily. In the present embodiment, the position of rollers 201 can be adjusted and set along the length of axle 205 to accommodate different wheel sizes by tightening a pair of nuts 207 on both sides of each group of rollers 201.

FIGS. 3A and 3B illustrate a wheel 301 on an exemplary wheel handling apparatus, in accordance with an embodiment of the present invention. FIG. 3A is a front perspective view of wheel 301 resting, with stability, on the apparatus, and FIG. 3B is a front perspective view of wheel 301 being lifted by the apparatus. Referring to FIG. 3B, to raise wheel 301, a user simply pushes a handle bar 303 downward. Conversely, to lower wheel 301, the user may allow handle bar 303 to move up to a higher position while controlling the speed with the right amount of resistance.

In typical use of a wheel handling apparatus in accordance with an embodiment of the present invention, a wheel to be mounted on the wheel hub of a vehicle is placed on the two roller axles such that the wheel can be rotated on the rollers. The user can release the braking system and adjust the height of the wheel by pressing the brake linkage against the handle bar and then adjusting the position of the handlebar to the desired height. This typically only requires one hand, so the user can use his other hand to hold the wheel for stability or to rotate the wheel if he so desires. When the desired height is achieved, the user re-engages the braking system by letting go of the brake linkage. The apparatus as a whole can typically be rolled freely on the ground anytime for horizontal positioning. Once the lug nut holes and the wheel studs are aligned, the user simply rolls the entire apparatus forward towards the vehicle to mount the wheel on the wheel hub of the vehicle. In some embodiments, the apparatus may be able to achieve the task of wheel mounting without the use of auxiliary assistive devices such as, but not limited to, hydraulic jacks or sockets for turning any parts of the apparatus. However, a separate jack may be required to jack up a vehicle to have its wheel removed or mounted. Some embodiments may only require vehicles to be jacked up a small distance in order to mount a wheel. For example, without limitation, a car vehicle may only need to be jacked up such that the tire is about 1 inch off the ground. Furthermore, by avoiding structural designs that put a great deal of stress on certain parts or joints, for example, without limitation, toe-lift structures, some embodiments can be manufactured using lightweight materials throughout while still supporting a good range of vehicle wheels with structural rigidity. These embodiments may result is an apparatus that is lightweight, compact and easy-to-use.

FIGS. 4A, 4B, and 4C illustrate an exemplary braking system for a wheel handling apparatus, in accordance with an embodiment of the present invention. FIG. 4A is a top perspective view of the braking system in a locked position. FIG. 4B is a top perspective view of the braking system in a released position, and FIG. 4C is a front perspective view of a brake linkage 401 in use. In the present embodiment, referring to FIG. 4A, when a user is not releasing the braking system, an L-shaped clamp 403 is typically pressed against a brake pad 405 due to tension from a spring 407 providing friction against lever movement. Clamp 403 rotates about a pivot 409 to move between the locked position and the released position. Referring to FIG. 4B, if the user needs to adjust the wheel height, the user may apply a force on clamp 401 towards a handle bar 411, as illustrated by way of example by an arrow 413. This rotates clamp 403 around pivot 409 to release clamp 403 from brake pad 405, as illustrated by way of example by an arrow 415, thus allowing free motion of the lever mechanism. Referring to FIG. 4C, brake linkage 401 straddles both clamps 403 to typically enable the user to release both clamps 403 with one hand.

FIGS. 5A, 5B, 5C and 5D illustrate exemplary elevation guidance systems for a mobile frame 501 of a wheel handling apparatus, in accordance with embodiments of the present invention. FIG. 5A is a front perspective view of an exemplary interdigitated slider. FIG. 5B is a front perspective view of an exemplary ring-on-post slider. FIG. 5C is a front perspective view of an exemplary linkage system, and FIG. 5D is a partial front perspective view of an exemplary rolling system. Referring to FIG. 5A, the interdigitated slider comprises a plate 503 attached to mobile frame 501 that fits between guide posts 505 attached to a base frame 500 in a guide post, paste, guide post configuration. Alternatively, the plate can be made up of multiple narrower plates rather than one big plate which are interspersed with more guiding posts. In other words, some embodiments, may have a guide post, plate, guide post, plate, guide post configuration, a guide post, plate, guide post, plate, guide post, plate, guide post configuration and so on. In the present embodiment, guide posts 505 typically ensure that plate 503 moves in a vertical direction up or down. Referring to FIG. 5B, the ring-on-post slider comprises rings 507 on mobile frame 501 that slide on guide posts 509 connected to base frame 500. In some embodiments, the guide posts may have a multiplicity of suitable shapes, and the rings may be implemented in various different shapes that fit the cross sectional profiles of the guiding posts. Referring to FIG. 5C, the linkage system comprises bars 511 that are pivotally connected to both mobile frame 501 and base frame 500. Referring to FIG. 5D, the rolling system comprises plate 519 attached on mobile frame 501 by screws or other means such as, but not limited to, bolts, clamps, pins, etc. Plate 519 may slide up or down a guiding bracket 520 connected to base frame 500. Plate 519 is fitted with rollers 512, 513, 514 and 515 which roll in guiding bracket 520 to provide a smooth sliding movement. To typically prevent faces 518 of rollers 512, 513, 514, and 515 from rubbing against the inner wall of guiding bracket 520 when sliding, rollers 516 and 517 are affixed to the center of guiding bracket 520 such that rollers 516 and 517 fit into a groove 521 on plate 519 to typically restrict the side-to-side movement of plate 519. Groove 521 may be sufficiently deep so that faces 522 of rollers 516 and 517 typically do not rub against the face of plate 519.

FIGS. 6A and 6B illustrate an exemplary braking system for a wheel handling apparatus comprising a central brake, in accordance with an embodiment of the present invention. FIG. 6A is a side perspective view of the apparatus, and FIG. 6B is a top view of the central brake. In the present embodiment, the braking system comprises only one brake tower 601. A stabilizer bar 603 connecting two lever arms 605 is added, and brake tower 601 may be affixed to the center of stabilizer bar 603. A brake module 607 may be affixed to a stabilizer bar 609 on a base frame 611. Stabilizer bars 603 and 609 are distanced such that brake tower 601 may penetrate through brake module 607. Brake module 607 comprises a pair of brake calipers 612 that may clamp onto brake tower 601 when the brake is engaged by the tension in a spring 613. Otherwise, brake tower 601 is typically free to move up and down through a support arc 615 of brake module 607. Brake pads 617 on the ends of calipers 612 may provide additional friction when the braking system is in a locked position. Calipers 612 are pivotally attached to support arc 615 at pivots 619. Referring to FIG. 6A, the engaging and releasing of calipers 612 may be actuated by pressing or releasing a brake lever 621, which is connected to brake module 607 through a brake cable 623. Referring to FIG. 6B, brake cable 623 may be enclosed in a cable sleeve 625. The braking system is similar to the braking mechanism of a bicycle. Note that the brake is engaged by default and is typically only released when the user presses brake lever 621.

FIG. 7 is a diagrammatic side view of an exemplary wheel handling apparatus, in accordance with an embodiment of the present invention. In the present embodiment, the apparatus comprises a spring 701 connecting a base frame 703 to a lever arm 705. Spring 701 may help to counter the weight of the load being lifted by providing aiding forces to the user's exertion. This way, in most instances, the user needs not exert as much force while adjusting the height of the wheels. Some embodiments may comprise a counterweight spring on each lever arm, and some embodiments may comprise one counterweight spring on a single lever arm. Other embodiments may have counterweight springs in various different locations such as, but not limited to, connecting a stabilizer bar on the base frame to a stabilizer bar connecting the lever arms or between the base frame and the handle bar.

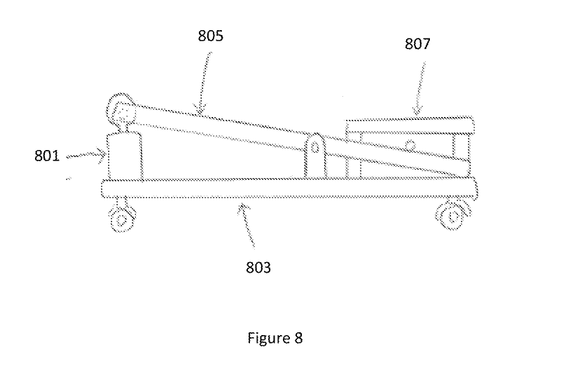

FIG. 8 is a diagrammatic side view of an exemplary wheel handling apparatus, in accordance with an embodiment of the present invention. In the present embodiment, the apparatus comprises an electric linear actuator 801 for height adjustment. Linear actuator 801 is mounted between a base frame 803 and a lever frame 805, and the actuation of linear actuator 801 causes lever frame 805 to raise and lower. This in turn causes a mobile frame 805 to raise or lower. The use of this electric linear actuator 801 may obviate the need for a braking system, as linear actuator 801 may be able to hold the load at nearly any position. Means for controlling linear actuator 801 such as, but not limited to, an ‘up’ button and a ‘down’ button or a switch provides the feature of lifting or lowering the wheel respectively. The use of electric linear actuator 801 may requires a battery pack or access to a power supply.

It is contemplated that some embodiments may implement the use of retractable frames so that the size of the apparatus can be changed at the user's discretion. Changing the size of the apparatus may enable the user to achieve various different actions including, without limitation, accommodating of more wheel sizes, making the apparatus more compact for storage in tight spaces, increasing the leverage ratio so as to reduce the effort required while performing height adjustment, etc. Retractable frames can easily be achieved by using hollow tubes of different sizes such that the tubes with smaller diameters can slide into the tubes with larger diameters. In some embodiments, the components of the apparatus may be made available separately or unassembled as a kit. For example, without limitation, a company may buy the frame from Manufacturer 1, a braking mechanism from Manufacturer 2, rollers from Manufacturer 3 and a counterweight spring from Manufacturer 4. The company may then package these parts together to be sold to end users as a kit. Those skilled in the art will readily recognize, in light of and in accordance with the teachings of the present invention, that some embodiments of the present invention may comprise a multiplicity of suitable features such as, but not limited to, foot actuated brakes, a foot actuated lever frame, a shelf or container for tools, lights, etc.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing an apparatus for handling a vehicle wheel according to the present invention will be apparent to those skilled in the art. Various aspects of the invention have been described above by way of illustration, and the specific embodiments disclosed are not intended to limit the invention to the particular forms disclosed. The particular implementation of the apparatus for handling a vehicle wheel may vary depending upon the particular context or application. By way of example, and not limitation, the apparatus for handling a vehicle wheel described in the foregoing were principally directed to personal vehicle implementations; however, similar techniques may instead be applied to mount or replace wheels on other types of vehicles such as, but not limited to, commercial vehicles, recreational vehicles, bicycles, motorcycles, all-terrain vehicles, tractors, heavy machinery, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A vehicle wheel handler comprising:
a base frame comprising two base arms and an end base member forming a generally U-shape substantially parallel to a floor;
a mobile frame comprising two supporting arms and an end member forming a generally U-shape;
an elevation guide system being joined to each of said two base arms and disposed proximate a distal end of said base aim, said elevation guide system being configured for slidable engagement with a one of said two supporting aims to enable vertical movement of said mobile frame relative to said base frame;
a roller support system being joined to each of said two supporting aims, said roller support system being configured to be operable for enabling a rotational positioning of a supported vehicle wheel;
a lifting member being joined to each of said two supporting aims; and
a lever frame comprising a handle and two lever arms, said lever aims being in pivotal engagement with said two base arms and in engagement with said lifting member for enabling a vertical positioning of the supported vehicle wheel.

2. The vehicle wheel handler as recited in claim 1, further comprising a brake system being configured for applying a holding force on said lever frame at a selected position.

3. The vehicle wheel handler as recited in claim 2, in which said brake system further comprises a brake release assembly for removing said holding force.

4. The vehicle wheel handler as recited in claim 3, in which said brake release assembly comprises a release handle disposed proximate said handle.

5. The vehicle wheel handler as recited in claim 2, in which said brake system further comprises a brake pad joined to each of said two base arms.

6. The vehicle wheel handler as recited in claim 2, in which said brake system further comprises a caliper type assembly for said holding force.

7. The vehicle wheel handler as recited in claim 1, further comprising a counterweight system being configured for countering a weight of the supported vehicle wheel during said vertical positioning.

8. The vehicle wheel handler as recited in claim 7, in which said counterweight system comprises at least one spring assembly in engagement with said lever frame and said base frame.

9. The vehicle wheel handler as recited in claim 1, further comprising a plurality of caster type wheels being joined to said base frame for enabling a horizontal positioning of the supported vehicle wheel.

10. The vehicle wheel handler as recited in claim 1, in which said elevation guide system further comprises a guiding bracket joined to each of said two base arms and a plate joined to each of said two supporting arms where said plate slidably engages said guiding bracket.

11. The vehicle wheel handler as recited in claim 10, in which said elevation guide system further comprises a plurality of rollers being rotatably joined to edges of said plate for engaging said guide bracket.

12. The vehicle wheel handler as recited in claim 11, in which said plate further comprises a vertical groove and said elevation guide system further comprises a plurality of rollers being rotatably joined to said guide bracket for engaging said vertical groove.

13. The vehicle wheel handler as recited in claim 1, in which said roller support system further comprises an axel and a plurality of rollers disposed on said axel for engaging the supported vehicle wheel.

14. The vehicle wheel handler as recited in claim 13, in which positions of said plurality of rollers are adjustable.

15. A vehicle wheel handler comprising:
a base frame comprising two base arms and an end base member forming a generally U-shape substantially parallel to a floor;
a mobile frame comprising two supporting arms and an end member forming a generally U-shape and having dimensions smaller than said base frame;
means for enabling vertical movement of said mobile frame relative to said base frame;
means, being joined to each of said two supporting arms, for enabling a rotational positioning of a supported vehicle wheel;
a lifting member being joined to each of said two supporting arms; and
means in pivotal engagement with said two base arms and in engagement with said lifting member for enabling a vertical positioning of the supported vehicle wheel.

16. The vehicle wheel handler as recited in claim 15, further comprising means for applying a holding force on said lever frame at a selected position.

17. The vehicle wheel handler as recited in claim 15, further comprising means for countering a weight of the supported vehicle wheel during said vertical positioning.

18. The vehicle wheel handler as recited in claim 15, further comprising means for enabling a horizontal positioning of the supported vehicle wheel.

19. A vehicle wheel handler comprising:
a base frame comprising two base arms and an end base member forming a generally U-shape substantially parallel to a floor;
a mobile frame comprising two supporting arms and an end member forming a generally U-shape and having dimensions smaller than said base frame;
an elevation guide system being joined to each of said two base arms and disposed proximate a distal end of said base aim, said elevation guide system being configured for slidable engagement with a one of said two supporting aims to enable vertical movement of said mobile frame relative to said base frame;
a roller support system being joined to each of said two supporting aims, said roller support system being configured to be operable for enabling a rotational positioning of a supported vehicle wheel;
a lifting member being joined to each of said two supporting aims;
a lever frame comprising a handle and two lever arms, said lever aims being in pivotal engagement with said two base arms and in engagement with said lifting member for enabling a vertical positioning of the supported vehicle wheel;
a brake system being configured for applying a holding force on said lever frame at a selected position;
a counterweight system being configured for countering a weight of the supported vehicle wheel during said vertical positioning; and
a plurality of caster type wheels being joined to said base frame for enabling a horizontal positioning of the supported vehicle wheel.

20. The vehicle wheel handler as recited in claim 19, in which said brake system further comprises a brake release assembly for removing said holding force, said brake release assembly comprises a release handle disposed proximate said handle, said brake system further comprises a brake pad joined to each of said two base arms, said counterweight system comprises at least one spring assembly in engagement with said lever frame and said base frame, said elevation guide system further comprises a guiding bracket joined to each of said two base arms and a plate joined to each of said two supporting arms where said plate slidably engages said guiding bracket, said elevation guide system further comprises a plurality of rollers being rotatably joined to edges of said plate for engaging said guide bracket, said plate further comprises a vertical groove and said elevation guide system further comprises a plurality of rollers being rotatably joined to said guide bracket for engaging said vertical groove, said roller support system further comprises an axel and a plurality of rollers disposed on said axel for engaging the supported vehicle wheel in which positions of said plurality of rollers are adjustable.
